(19) United States
(12) Patent Application Publication
(10) Pub. No.: US 2026/0100940 A1
(43) Pub. Date: Apr. 9, 2026

(54) APPARATUSES AND METHODS FOR FACILITATING AN EQUIPMENT/RESOURCE LOCK WITH NETWORK/SYSTEM SPECIFIC HOST IDENTIFIERS COMBINED WITH USER PROVIDED CREDENTIALS

(71) Applicant: CIENA CORPORATION, Hanover, MD (US)

(72) Inventors: Andrew Alexander Parsons, Ottawa (CA); Christopher John Brown, Ottawa (CA); Sandra Lynn Fougere, Nepean (CA); Brian Moore, Stittsville (CA); David James Chow, Kanata (CA); Magdalena Charbonneau, Ottawa (CA); Colin William Kemp, Ottawa (CA)

(73) Assignee: CIENA CORPORATION, Hanover, MD (US)

(21) Appl. No.: 18/907,745

(22) Filed: Oct. 7, 2024

(51) Int. Cl. H04L 9/40

(52) U.S. Cl. CPC H04L 63/08

(57) ABSTRACT

Aspects of the subject disclosure may include, for example, obtaining a first instance of a host identifier associated with a first server based on a communicative coupling between a device and the first server, obtaining a first instance of a credential associated with a first user, and activating a lock feature in respect of a resource coupled to the device based on the first instance of the host identifier associated with the first server and the first instance of the credential, resulting in a first activation, wherein upon the first activation the resource is restricted to operating in a first communication network associated with the first server. Other embodiments are disclosed.

### FIELD OF THE DISCLOSURE

The subject disclosure relates to apparatuses and methods for facilitating an equipment/resource lock with network/system specific host identifiers combined with user provided credentials.

### BACKGROUND

As the world increasingly becomes connected via vast communication networks and systems, additional resources may need to be deployed/utilized by a network/system operator or service provider to satisfy demand. For example, there may be practical limits in respect of an amount of traffic or load that a given resource may be able to accommodate. As a result, it is not uncommon to see whole facilities (e.g., server farms) allocated to facilitating/provisioning communication services.

It can be difficult for a network/system operator or service provider to maintain oversight in respect of equipment or resources. This is particularly true when one considers not only equipment/resources that are deployed or utilized as part of active network/system operations, but also any inventory that provides spare capacity. A given resource (e.g., a line-item unit, a network card, or the like) may have value (e.g., monetary value, functional value, etc.), which in turn makes the resource attractive/susceptible to theft. As a result, network/system operators and service providers may need to invest in, e.g., security personnel/guards, facility locks/alarms, etc., in an effort to safeguard equipment/resources, without necessarily any confidence that such investments/efforts will be adequate/sufficient.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a system in accordance with various aspects described herein.

FIGS. 2-3 depict illustrative embodiments of methods in accordance with various aspects described herein.

FIG. 4 is a block diagram of an example, non-limiting embodiment of a computing environment in accordance with various aspects described herein.

### DETAILED DESCRIPTION

The subject disclosure describes, among other things, illustrative embodiments for facilitating an equipment or resource lock with network specific server identifiers and user provided credentials. Other embodiments are described in the subject disclosure.

One or more aspects of the subject disclosure include obtaining a first instance of a host identifier associated with a first server based on a communicative coupling between a device and the first server; obtaining a first instance of a credential associated with a first user; and activating a lock feature in respect of a resource coupled to the device based on the first instance of the host identifier associated with the first server and the first instance of the credential, resulting in a first activation, wherein upon the first activation the resource is restricted to operating in a first communication network associated with the first server for a duration that the lock feature is activated in conjunction with the first activation.

One or more aspects of the subject disclosure include obtaining a first instance of a host identifier associated with a first server based on a communicative coupling between a processing system and the first server; obtaining a first instance of a credential associated with a first user; and activating a lock feature in respect of a resource coupled to the processing system based on the first instance of the host identifier associated with the first server and the first instance of the credential, wherein upon the activating the resource is restricted to operating in a first communication network associated with the first server for a duration that the lock feature is activated in conjunction with the activating.

One or more aspects of the subject disclosure include obtaining, by a processing system including a processor, a first instance of a host identifier associated with a first server based on a communicative coupling between the processing system and the first server; obtaining, by the processing system, a first instance of a credential associated with a first user; and activating, by the processing system, a lock feature in respect of a resource coupled to the processing system based on the first instance of the host identifier associated with the first server and the first instance of the credential, wherein upon the activating the resource is restricted to operating in a first communication network associated with the first server for a duration that the lock feature is activated in conjunction with the activating.

By way of introduction, aspects of this disclosure are based on a recognition that resources or equipment of a network/system operator or service provider have an intrinsic or inherent value. As a result, such resources or equipment become an attractive target for theft. In view of the same, and as explained in further detail below, aspects of this disclosure provide an ability to reduce the value of such resources or equipment when such resources or equipment are removed from their intended/proper/authorized locations. This reduction in value, in turn, decreases the incentive for a nefarious actor to steal the equipment or resources.

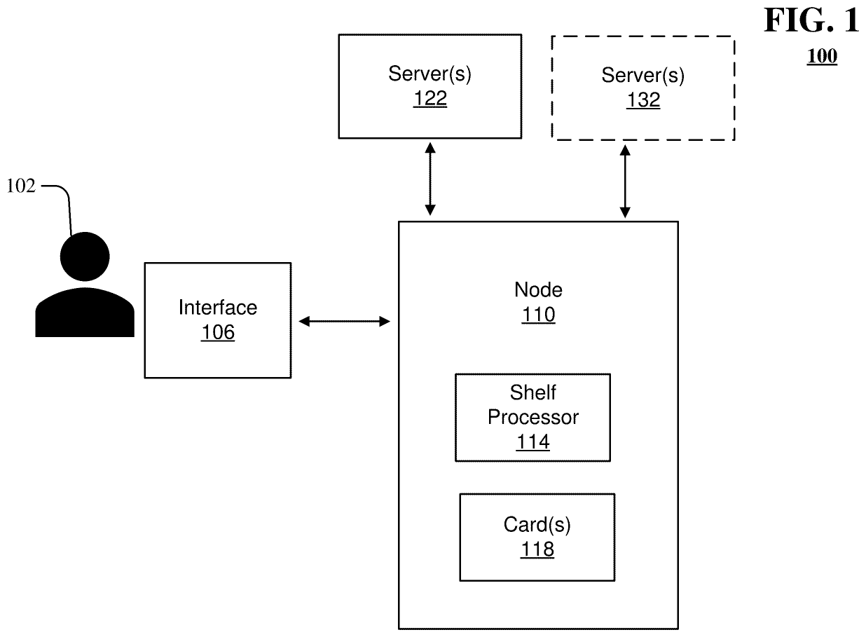

Referring now to FIG. 1, a block diagram of an exemplary, non-limiting embodiment of a system 100 in accordance with various aspects described herein is shown. The system 100 may be included as part of a communication network/system.

The system 100 may include one or more users 102, an interface 106, a node 110 (potentially inclusive of a shelf processor 114 and/or one or more cards 118), and/or one or more servers 122. In some embodiments, the node 110 may serve as a chassis, rack, or receptacle that may seat the shelf processor 114 and/or the one or more cards 118.

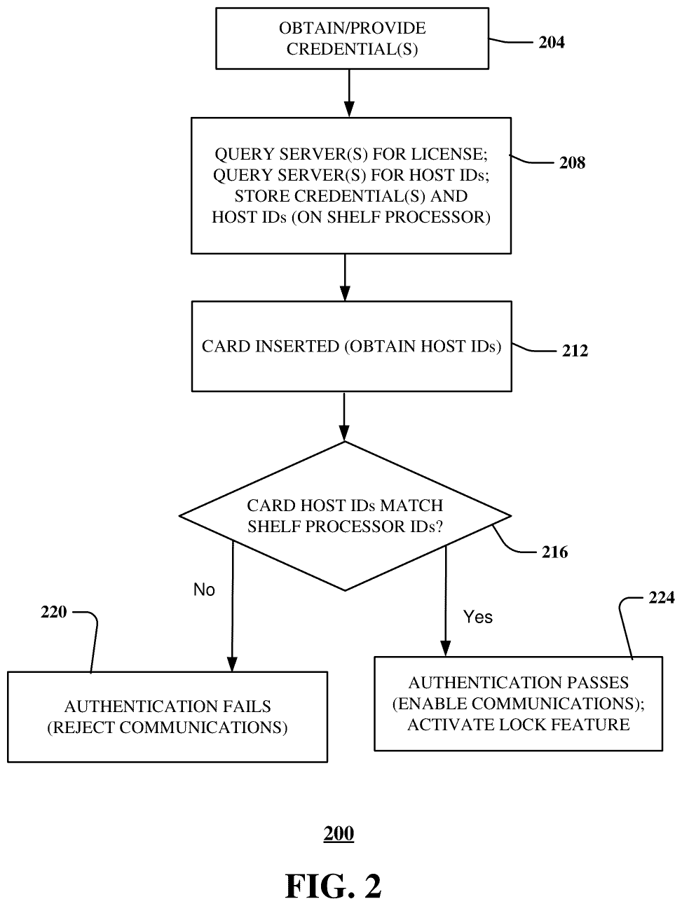

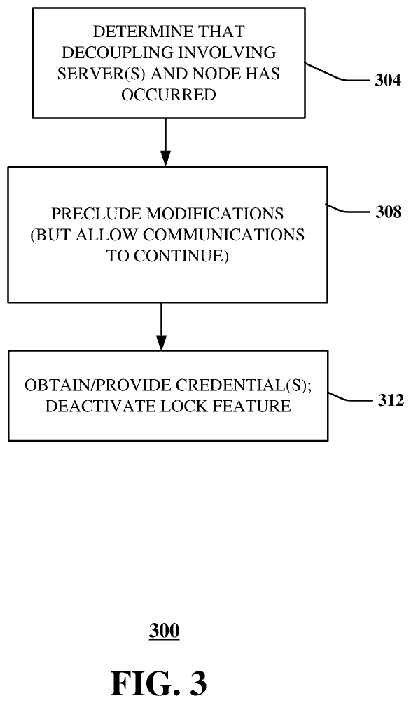

With reference now to FIG. 1, FIG. 2, and FIG. 3, various operations of a method 200 and a method 300 that may be facilitated via the system 100 are shown. It is understood and appreciated that one or more of the operations may be facilitated or performed in respect of entities that are different from what is shown in FIG. 1. The operations of the method 200 and the method 300 are described below in respect of the blocks shown in FIG. 2 and FIG. 3.

As part of block 204, the user(s) 102 (which may include, or represent, operations support system (OSS) personnel, staff, or the like) may supply/provide one or more credentials via the interface 106. For example, the credential(s) may include a username and password, a personal identification number (PIN), a biometric credential, or the like. The credential(s) may serve to validate that a given user 102 is authorized to access the system 100, and in particular, is authorized to enable or disable a lock feature in respect of the node 110 (or one or more components or devices thereof, such as for example the shelf processor 114 and/or the card(s) 118). The interface 106 may be supported by one or more computing or communication devices, such as for example a desktop computer, a laptop, a tablet, a mobile communication device (e.g., a smartphone), etc. The interface 106 may be operative in conjunction with, or may incorporate aspects of, a command line interface (CLI), Transaction Language 1 (TL1), a network management system, an element management system, or the like. The interface 106 may provide the credential(s) to the node 110; on the basis of the same, the shelf processor 114 and/or the card(s) 118 may obtain (and store) the credential(s).

For reasons that will become clearer in the description that follows, operations of the block 204 may correspond to an activation process that may be used to setup or establish authorization criteria that may be required to deactivate an equipment lock. Activation may utilize authentication, where in some embodiments authentication corresponds to user access control to/of a shelf and ownership of a valid license to allow activation.

As part of block 208, the shelf processor 114 may query the server(s) 122 for a license. Based on that license query (and any accompanying license), the shelf processor 114 may then query the server(s) 122 for host identifiers (IDs) that may serve to identify the server(s) 122 as anchors or anchor points. The shelf processor 114 may store the credential(s) and the host IDs.

As part of block 212, it may be assumed that a card 118 has been inserted into the node 110. Insertion in the context may refer to coupling a communication connection involving the card 118 and the node 110, installing the card 118 into a socket or an adapter of the node 110, etc. In block 212, the card 118 may obtain one or more of the host IDs of the server(s) 122 in a manner similar to what was described above in respect of block 208.

In block 216, an authentication process/procedure may be undertaken. As part of that authentication process/procedure, a determination may be made whether the host IDs of the card 118 (obtained as part of block 212) match the host IDs of the shelf processor 114 (obtained as part of block 208). In this regard, the determination of block 216 may be facilitated by a comparison of the host IDs obtained by the card 118 and the shelf processor 114. If the determination/comparison is answered in the negative, flow may proceed to block 220; otherwise, flow may proceed to block 224.

In block 220, the authentication process/procedure (of block 216) may be declared as having failed. In this respect, any attempts to facilitate communications may be precluded/prohibited.

In block 224, the authentication (of block 216) may be declared as having passed or been successful. In this respect, attempts to facilitate communications may be enabled/allowed. As part of block 224, a lock feature in respect of the shelf processor 114 and/or the card 118 may be activated or placed into a lock state/status. The activation of the lock feature may result in the shelf processor 114 and/or the card 118 from becoming inoperable if they are removed from the communication network/system they are locked to (where such communication network/system may be fairly represented by the host IDs). Thus, the activation of the lock feature may serve to thwart attempts to steal the shelf processor 114 and/or the card 118, as the shelf processor 114 and/or the card 118 may effectively/operationally be bound to the environment where the lock has been activated.

Following the execution of the operations of the block 224, the communications may (continue to) be facilitated via the node 110 (e.g., via the shelf processor 114 and/or the card 118). At some point thereafter, it may be assumed that the server(s) 122 become(s) decoupled from the node 110. For example, it may be the case that the decoupling is a result of the server(s) 122 becoming inoperable due to any variety of reasons, such as for example due to a natural disaster that compromises the server(s) 122. In another instance, it may be the case that the server(s) 122 are being purposefully or intentionally decommissioned, perhaps due to an availability of more energy-efficient hardware or enhanced functionalities. Irrespective of the reasons behind/for the decoupling, it may be the case that the lock feature may need to be (at least temporarily) deactivated to allow new or replacement servers (see, e.g., server(s) 132 in FIG. 1) to be installed.

With the foregoing in mind, and with reference to block 304, a determination may be made that a decoupling involving the server(s) 122 and the node 110 has occurred. In some embodiments, the determination of block 304 may be based on an expiration of a timer or timeout, such as for example in relation to (an absence of a detection of) a signal (e.g., a heartbeat signal) between the server(s) 122 and the node 110 beyond a threshold amount of time. The threshold amount of time may be set to a default value that may be selectively overridden or replaced with a user-defined value in some embodiments.

Upon the expiration of the timer/timeout, functionality (e.g., communications) may still be allowed to continue, but modifications may generally be prohibited or excluded, as represented by block 308. In this regard, communications-based operations (and other functionality) involving the node 110 might not be negatively impacted by the loss or decoupling involving the server(s) 122, which may be important from a perspective of satisfying quality of service (QoS) or quality of experience (QoE) metrics or requirements. However, as described above, the occurrence of the expiration of the timer/timeout may preclude modifications being made.

To facilitate installation of new or replacement server(s) 132, the user 102 may (again) provide the credential(s) by way of the interface 106 as part of block 312. Operations of block 312 may be similar to the operations of the block 204; however, in the case of block 312 the credential(s) may serve to deactivate the lock feature (compare with blocks 204 and 224: credential(s) serving to activate the lock feature).

Once the lock feature has been deactivated (as part of block 312), the methodology associated with block 208 may be applied to obtain the host IDs associated with the new/replacement server(s) 132, and the method 200 may proceed from that point/block. In this regard, it is noted that operations of the methods 200 and 300 may be combined with one another and may be executed iteratively or repeatedly, such as anytime new or replacement server(s) may be needed or desired to be installed. Furthermore, the ability to selectively activate or deactivate the lock feature may provide a benefit of guarding against theft as described above, while at the same time still providing flexibility to replace or upgrade server(s) (or other assets). In this regard, and as used herein, the terms first, second, third, and so on, may be used to distinguish between instances of blocks of the methods 200 and 300, instances of servers, instances of activation or deactivation, instances of credentials, and so on.

While for purposes of simplicity of explanation, the respective processes are shown and described as a series of blocks in FIG. 2 and FIG. 3, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein. Operations associated with a given block may be based on operations associated with one or more other blocks.

As one skilled in the art will appreciate, the dual set of information (server/host IDs and user supplied credentials) provides a number of benefits. For example, a user/customer may exercise control and management of the lock feature capability. Maintenance and recovery procedures may be facilitated to mitigate against loss of access to server(s). An ability may be obtained to seamlessly move equipment around the domain of a communication network/system, while ensuring that such movements are authorized or permitted.

Enhanced reliability/security may be realized/obtained via an implementation of aspects of this disclosure. For example, for a nefarious actor to defeat/overcome the security aspects of this disclosure in respect of a shelf processor (see shelf processor 114 of FIG. 1), a card (see card 118 of FIG. 1), or other resource/asset, the nefarious actor would need to: (1) spoof or replicate the host IDs when installing the (stolen) resource in the new communication network/system environment, (2) have knowledge of, and an ability to replicate, the user credential(s), and (3) gain access to the lock feature to facilitate deactivating the lock feature. It is anticipated that most nefarious actors would lack the means or sophistication to be able to successfully install a stolen resource given (1)-(3) described just above.

As the foregoing demonstrates, the various aspects of this disclosure are integrated as part of numerous practical applications involving a commissioning and decommissioning of resources in respect of communication networks and systems. Aspects of this disclosure may be used to enhance a security profile associated with a resource (e.g., a shelf processor, a card, etc.) that may be utilized as part of a communication network or system, by providing an ability/capability to lock the resource to specific, user/customer defined regions of the communication network/system. This enhancement in the security/security profile, in turn, reduces the incentive for a nefarious actor to attempt to steal the resource or utilize the resource in an unauthorized manner (e.g., as part of another communication network or system). At the same time, aspects of this disclosure enable a resource to be transferred or reallocated from a first portion of a network or system to a second portion of the network or system (or, analogously, from a first network/system to a second network/system), via the override mechanism that is effectively achieved/realized via a selective deactivation (and then activation/reactivation) of the lock feature referenced above. In this respect, the various aspects of this disclosure represent substantial improvements to technology, particularly with reference to scarce and valuable resources. In brief, and as one skilled in the art will appreciate based on a review of this disclosure, the various aspects of this disclosure are not directed to abstract ideas. To the contrary, the various aspects of this disclosure are directed to, and encompass, significantly more than any abstract idea standing alone.

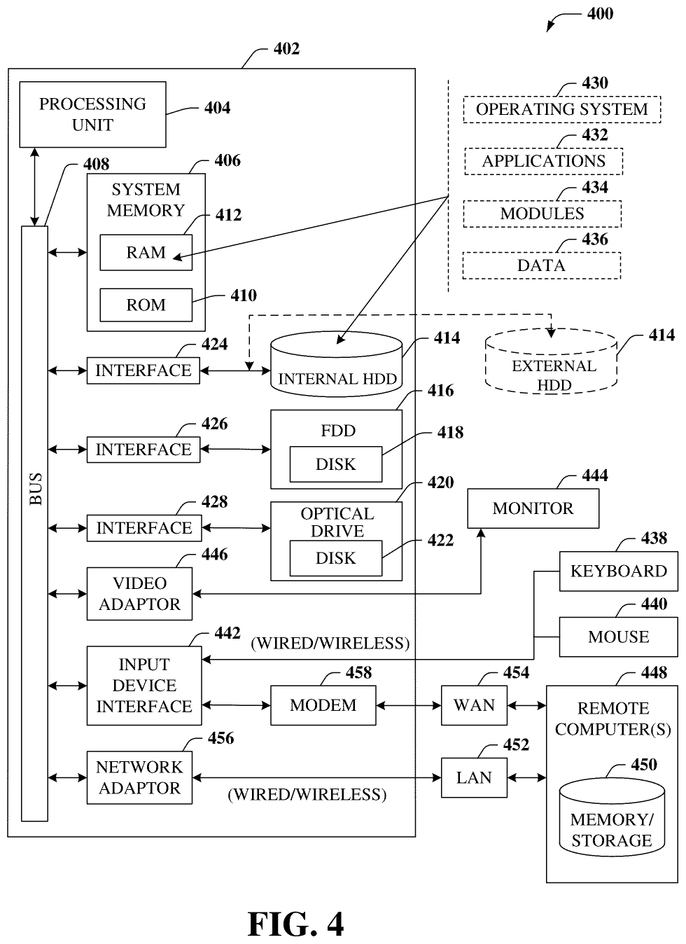

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. For example, the computing environment 400 can facilitate, in whole or in part, obtaining a first instance of a host identifier associated with a first server based on a communicative coupling between a device and the first server, obtaining a first instance of a credential associated with a first user, and activating a lock feature in respect of a resource coupled to the device based on the first instance of the host identifier associated with the first server and the first instance of the credential, resulting in a first activation, wherein upon the first activation the resource is restricted to operating in a first communication network associated with the first server for a duration that the lock feature is activated in conjunction with the first activation. The computing environment 400 can facilitate, in whole or in part, obtaining a first instance of a host identifier associated with a first server based on a communicative coupling between a processing system and the first server, obtaining a first instance of a credential associated with a first user, and activating a lock feature in respect of a resource coupled to the processing system based on the first instance of the host identifier associated with the first server and the first instance of the credential, wherein upon the activating the resource is restricted to operating in a first communication network associated with the first server for a duration that the lock feature is activated in conjunction with the activating. The computing environment 400 can facilitate, in whole or in part, obtaining, by a processing system including a processor, a first instance of a host identifier associated with a first server based on a communicative coupling between the processing system and the first server, obtaining, by the processing system, a first instance of a credential associated with a first user, and activating, by the processing system, a lock feature in respect of a resource coupled to the processing system based on the first instance of the host identifier associated with the first server and the first instance of the credential, wherein upon the activating the resource is restricted to operating in a first communication network associated with the first server for a duration that the lock feature is activated in conjunction with the activating.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data. Computer-readable storage media can comprise the widest variety of storage media including tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure.

The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
obtaining a first instance of a host identifier associated with a first server based on a communicative coupling between the device and the first server;
obtaining a first instance of a credential associated with a first user; and
activating a lock feature in respect of a resource coupled to the device based on the first instance of the host identifier associated with the first server and the first instance of the credential, resulting in a first activation, wherein upon the first activation the resource is restricted to operating in a first communication network associated with the first server for a duration that the lock feature is activated in conjunction with the first activation.

2. The device of claim 1, wherein the resource includes a network card, a shelf processor, or a combination thereof.

3. The device of claim 1, wherein the operations further comprise:
querying the first server for a license, resulting in a first query;
obtaining a license based on the first query; and
querying the first server based on the license, resulting in a second query,
wherein the obtaining of the first instance of the host identifier is based on the second query.

4. The device of claim 1, wherein the operations further comprise:
based on the first activation, facilitating communications in the first communication network using the resource.

5. The device of claim 4, wherein the facilitating of the communications in the first communication network is based on a performance of an authentication procedure.

6. The device of claim 5, wherein the performance of the authentication procedure comprises performing a comparison between the first instance of the host identifier and a second instance of the host identifier.

7. The device of claim 4, wherein the operations further comprise:
subsequent to the facilitating of the communications, determining that there is a communicative decoupling between the device and the first server.

8. The device of claim 7, wherein the determining that there is a communicative decoupling between the device and the first server is based on an expiration of a timer.

9. The device of claim 8, wherein the expiration of the timer is based on a threshold amount of time that corresponds to a user-defined value.

10. The device of claim 7, wherein the operations further comprise:
based on the determining that there is the communicative decoupling between the device and the first server, precluding a modification to the resource while still facilitating the communications using the resource.

11. The device of claim 7, wherein the operations further comprise:
based on the determining that there is the communicative decoupling between the device and the first server, obtaining a second instance of the credential.

12. The device of claim 11, wherein the operations further comprise:
based on the obtaining of the second instance of the credential, deactivating the lock feature in respect of the resource.

13. The device of claim 12, wherein the operations further comprise:
based on the deactivating of the lock feature in respect of the resource, obtaining a first instance of a host identifier associated with a second server based on a communicative coupling between the device and the second server; and
activating the lock feature in respect of the resource coupled to the device based on the first instance of the host identifier associated with the second server and the second instance of the credential, resulting in a second activation, wherein upon the second activation the resource is restricted to operating in a second communication network associated with the second server for a duration that the lock feature is activated in conjunction with the second activation.

14. The device of claim 1, wherein the credential includes a username and password, a personal identification number, a biometric credential, or any combination thereof.

15. The device of claim 1, wherein the obtaining of the credential comprises a use of an interface that is operative in accordance with a command line interface (CLI), Transaction Language 1 (TL1), a network management system, an element management system, or any combination thereof.

16. A non-transitory machine-readable medium, comprising executable instructions that, when executed by a processing system including a processor, facilitate performance of operations, the operations comprising:
obtaining a first instance of a host identifier associated with a first server based on a communicative coupling between the processing system and the first server;
obtaining a first instance of a credential associated with a first user; and
activating a lock feature in respect of a resource coupled to the processing system based on the first instance of the host identifier associated with the first server and the first instance of the credential, wherein upon the activating the resource is restricted to operating in a first communication network associated with the first server for a duration that the lock feature is activated.

17. The non-transitory machine-readable medium of claim 16, wherein the operations further comprise:
subsequent to the activating of the lock feature, detecting that there is a communicative decoupling between the processing system and the first server; and
based on the detecting, obtaining a second instance of the credential that deactivates the lock feature in respect of the resource.

18. The non-transitory machine-readable medium of claim 17, wherein the operations further comprise:
subsequent to the obtaining of the second instance of the credential, reactivating the lock feature in respect of the resource coupled to the processing system based on a first instance of a host identifier associated with a second server, wherein upon the reactivating the resource is restricted to operating in a second communication network associated with the second server and is precluded from operating in the first communication network for a duration that the lock feature is activated in conjunction with the reactivating.

19. A method, comprising:
obtaining, by a processing system including a processor, a first instance of a host identifier associated with a first server based on a communicative coupling between the processing system and the first server;
obtaining, by the processing system, a first instance of a credential associated with a first user; and
activating, by the processing system, a lock feature in respect of a resource coupled to the processing system based on the first instance of the host identifier associated with the first server and the first instance of the credential, wherein upon the activating the resource is restricted to operating in a first communication network associated with the first server for a duration that the lock feature is activated.

20. The method of claim 19, further comprising:
subsequent to the activating, obtaining, by the processing system, a second instance of the credential that deactivates the lock feature in respect of the resource; and
based on the obtaining of the second instance of the credential, reactivating the lock feature in respect of the resource, wherein upon the reactivating the resource is restricted to operating in a second communication network associated with a second server for a duration that the lock feature is activated in conjunction with the reactivating, and wherein the second server is more energy efficient than the first server.
